(19) United States
(12) Patent Application Publication
(10) Pub. No.: US 2015/0343652 A1
(43) Pub. Date: Dec. 3, 2015

(54) ROTARY ELECTRIC SHAVER

(71) Applicant: Izumi Products Company, Matsumoto-shi (JP)

(72) Inventor: Yoshiyuki MIMURA, Matsumoto-shi (JP)

(73) Assignee: Izumi Products Company, Matsumoto-shi (JP)

(21) Appl. No.: 14/718,268

(22) Filed: May 21, 2015

(30) Foreign Application Priority Data
May 30, 2014 (JP) 2014-113266

(51) Int. Cl. B26B 19/14

(52) U.S. Cl. CPC B26B 19/141

(57) ABSTRACT

There is provided a rotary electric shaver which can improve cutting quality and can prevent a blade edge from becoming blunt.

A rotary electric shaver according to the present invention includes a blade unit which has an outer blade having multiple hair inlets formed therein and an inner blade rotating while coming into sliding contact with a lower surface of the outer blade. The inner blade has multiple small blades, and the small blades are formed in a shape in which rake angles of a blade edge are a small angle and a large angle depending on radial positions.

### CROSS-REFERENCE TO RIMMED APPLICATION

This application is based upon and claims the benefit of priority of the prior Japanese Patent Application No. P2014-113266, filed on May 30, 2014, and the entire contents of which are incorporated herein by reference.

### FIELD

The present invention relates to a rotary electric shaver.

### BACKGROUND

For example, PTL 1 discloses a rotary electric shaver which cuts hair entering multiple hair inlets while including an outer blade having the multiple hair inlets formed therein and an inner blade rotating while coming into sliding contact with a lower surface of the outer blade.

### CITATION LIST

### Patent Literature

PTL 1: JP-A-2007-135991

### SUMMARY

Here, the present inventor has extensively studied and found out that the rotary electric shaver including the inner blade as disclosed in PTL 1 can improve hair cutting quality by forming a rake angle of a blade edge of the inner blade (small blade) into an acute angle.

On the other hand, if the rake angle of the blade edge of the inner blade (small blade) is formed into the acute angle, a shape of the blade edge becomes thin, thereby weakening rigidity thereof. Accordingly, the present inventor has found out that a conflicting problem occurs in that the cutting quality decreases since the blade edge gradually becomes blunt as the blade edge is used (cuts the hair) frequently.

The present invention is made in view of the above-described circumstances, and an object thereof is to provide a rotary electric shaver which can improve cutting quality and can prevent a blade edge from becoming blunt.

### Solution to Problem

As one embodiment, means for solving the above-described problem is disclosed as follows.

According to the disclosure, there is provided a rotary electric shaver which includes a blade unit having an outer blade having multiple hair inlets formed therein and an inner blade rotating while coming into sliding contact with a lower surface of the outer blade. The inner blade has multiple small blades, and the small blades are formed in a shape in which rake angles of a blade edge are a small angle and a large angle depending on radial positions of the small blades.

### Advantageous Effects

According to the present invention, cutting quality can be improved when hair is cut, and it is possible to prevent a blade edge from becoming blunt progressively.

### BRIEF DESCRIPTION OF THE DRAWINGS

FIG. 1 is a schematic view (perspective view) illustrating an example of a rotary electric shaver according to an embodiment of the present invention.

FIG. 2 a schematic view (exploded perspective view) illustrating an example of a head unit in the rotary electric shaver illustrated in FIG. 1.

FIGS. 3A and 3B are schematic views illustrating an example of an inner blade in the rotary electric shaver illustrated in FIG. 1.

FIG. 4 is a schematic view (side view) illustrating a small blade of the inner blade and a portion of an outer blade in the rotary electric shaver illustrated in FIG. 1.

FIGS. 5A to 5D are enlarged views illustrating an example of the small blade of the inner blade illustrated in FIGS. 3A and 3B.

### DESCRIPTION OF THE EMBODIMENTS

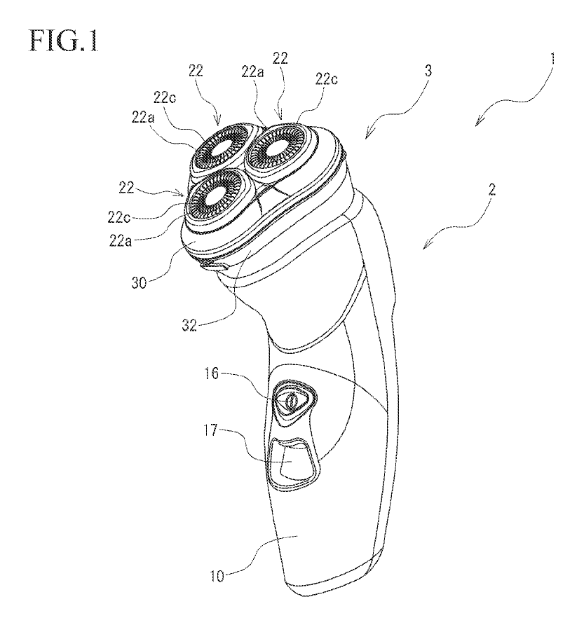

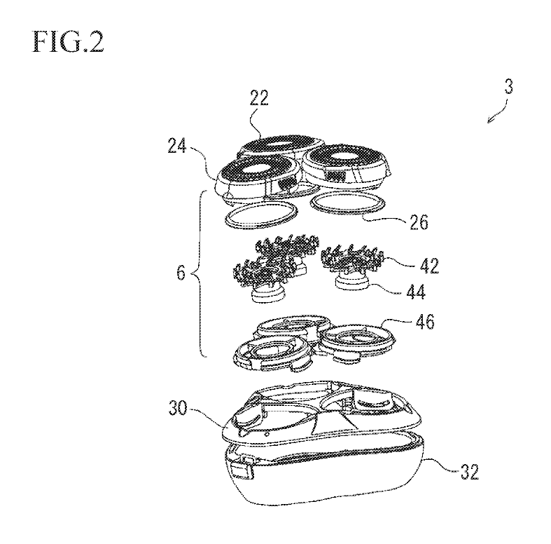

Hereinafter, a first embodiment of the present invention will be described in detail with reference to the drawings. FIG. 1 is a schematic view (perspective view) illustrating an example of a rotary electric shaver 1 according to the present embodiment. In addition, FIG. 2 is a schematic view (exploded perspective view) illustrating an example of a head unit 3 of the rotary electric shaver 1. In all the drawings for describing embodiments, the same reference numerals are given to members having the same function, and in some cases, repeated description thereof will be omitted.

As illustrated in FIGS. 1 and 2, the rotary electric shaver 1 according to the present embodiment includes an outer blade 22 having multiple penetrating hair inlets (slits to be described later) 22c formed therein and an inner blade 42 rotating while coming into sliding contact with a lower surface of the outer blade 22, and is a rotary electric shaver which cuts hair entering the multiple hair inlets 22c by using the outer blade 22 and the inner blade 42. In this invention, examples of the hairs include beards, mustache, whisker, and the like. An example will be described in which the rotary electric shaver 1 has three sets of blade unit 6 including the outer blade 22 and the inner blade 42. However, the present embodiment is not limited thereto.

In FIG. 1, the reference numeral 2 is a main body, and includes a substantially cylindrical case 10. A motor for rotatably driving the inner blade 42, a battery for supplying electric power to the motor, and a control unit for controlling the rotary drive (all not illustrated) are accommodated inside the case 10. A switch button 16 for turning on and off a power source is disposed on a front surface of the case 10. A display unit 17 having an LEI) lamp for indicating battery residual capacity is disposed below the switch button 16.

As illustrated in FIG. 2, the head unit 3 includes a head case 32 which is held by being connected to an upper portion of a case 10 of a main body 2, a blade frame 30 which covers the head case 32 from above, a drive mechanism (not illustrated) which is accommodated in an inner bottom portion of the head case 32, and the three sets of blade unit 6 which are held in the blade frame 30 so as to be slightly and vertically movable and swingable. Here, each blade unit 6 includes the outer blade 22 having a substantially disc shape and the inner blade 42 rotating while coming into sliding contact with the lower surface (inner surface) of the outer blade 22, in addition, the three sets of blade unit 6 are arranged so as to form a triangle in a plane view. As described above, the present embodiment employs a case example where the three sets of blade unit 6 are included therein. However, a basic configuration may be similarly conceivable even in a case where blade units are included in an alternative combination other than the three sets.

Here, the outer blade 22 is configured so that multiple radial slits 22c serving as hair inlets are formed to penetrate in an axial direction (that is, direction the same as the axial direction of a rotation axis of the inner blade) and the inner blade 42 cuts hair entering the slits 22c. That is, the outer blade 22 is configured so that an upper surface 22a serves as a shaving surface which comes into contact with skin of a user and the slits 22e are open on the upper surface (shaving surface) 22a. As an example, the upper surface (shaving surface) 22a is formed in an annular plane. In addition, the outer blade 22 has a shape whose peripheral edge is bent downward and an outer blade ring 24 is fitted into the peripheral edge. A stopper ring 26 is fitted into an inner periphery of the outer blade ring 24, and the outer blade 22 is fixed to the outer blade ring 24.

On the other hand, the inner blade 42 is fixed to an inner blade holder 44, and a recess to which an upper end of an inner blade drive shaft (not illustrated) connected to an output shaft of the motor is fitted is formed in a lower portion of the inner blade holder 44. The inner blade 42 is held so as to be swingable to the outer blade 22 side by an inner blade rest 46 fitted into the outer blade 24, thereby forming three sets of independent blade unit 6.

The blade units 6 are assembled by including the above-described configuration. In this manner, the inner blade 42 (small blade 42A to be described later) is in a state of coming into contact with the outer blade 22 (lower surface 22b to be described later). In this state, the inner blade 42 is rotatably driven, thereby cutting the hair entering the hair inlets (slits) 22c by using a blade edge of the inner blade 42 (small blade 42A).

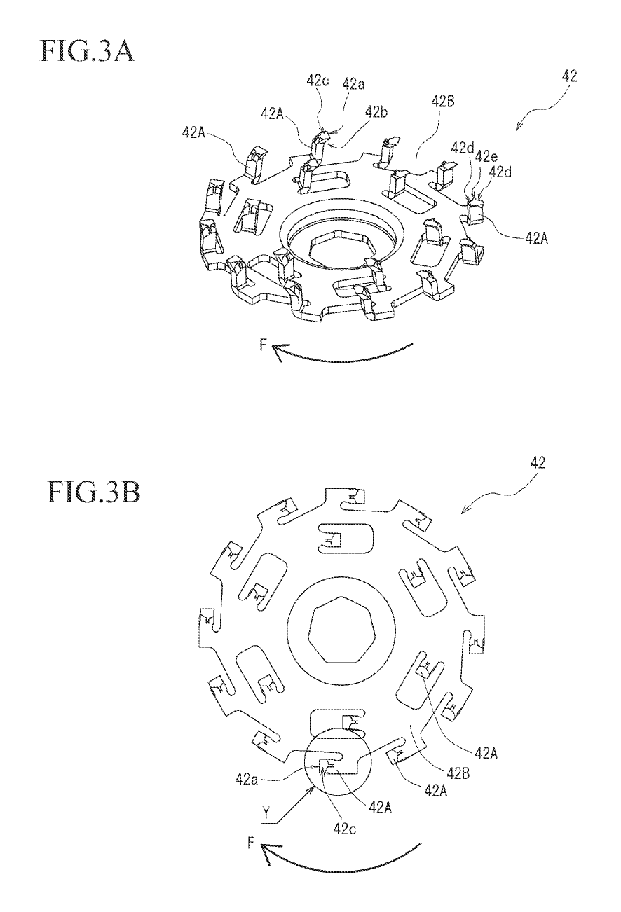

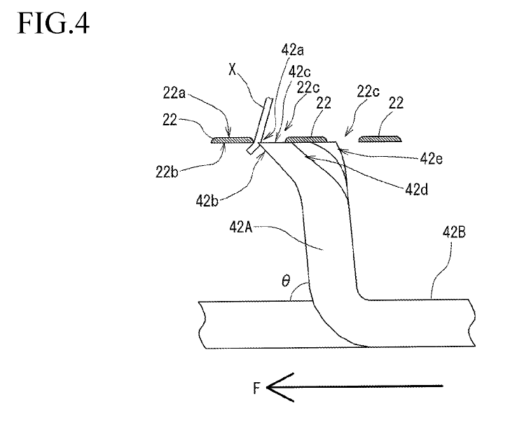

Hereinafter, a configuration of the inner blade 42 will be described in detail with reference to FIGS. 3A, 3B, and 4. FIGS. 3A and 3B are schematic views illustrating an example of the inner blade 42, FIG. 3A is a perspective view, and FIG. 3B is a plan view. In addition, FIG. 4 is an enlarged view (side view) illustrating the small blade 42A of the inner blade 42 and a portion of the outer blade 22. In the respective drawings, the rotation, direction of the inner blade 42 is illustrated as a direction of an arrow F.

As illustrated in FIGS. 3A, 3B, and 4, the inner blade 42 according to the present embodiment is configured to include multiple small blades 42A in which a metal plate is partially disposed upright with respect to a plate surface 42B (reference numeral is given to only a few small blades in order to simplify the illustration). As an example, the small blades 42A are disposed upright so that an angle θ of a front side angle (upright angle) in the rotation direction with respect to the plate surface 42B of the metal plate satisfies 45°≦θ≦135°. An upper end portion of the small blades 42A is formed to be bent forward in the rotation direction.

In the present embodiment, the inner blade 42 is formed as an integral structure in such a way that a metal plate made of stainless steel is used, and punching and bending are performed thereon by means of pressing. In this manner, the inner blade 42 can be formed so as to have a simple structure through fewer processes. Accordingly, it is possible to decrease component cost and assembly cost. However, the present embodiment is not limited to the integral structure.

As an example, the small blade 42A according to the present embodiment has a substantially prismatic shape having a rectangular cross section in which one side is approximately 1 mm, the other side is approximately 0.5 mm, and the length (length from a root to the blade edge) is approximately 3 mm. However, the present embodiment is not limited to the dimension and the shape. If the length is further shortened, it is possible to improve rigidity of the small blade 42A, and it is possible to prevent deflection or vibration from occurring during operation. Therefore, cutting quality is further improved.

In addition, in the small blade 42A, a blade edge 42a for cutting hair entering the hair inlets (slits) 22c is formed in a front side distal end in the rotation direction. More specifically, in the small blade 42A, an upper end edge defined by a front side surface 42b and an upper end surface 42c in the rotation direction configures the blade edge 42a.

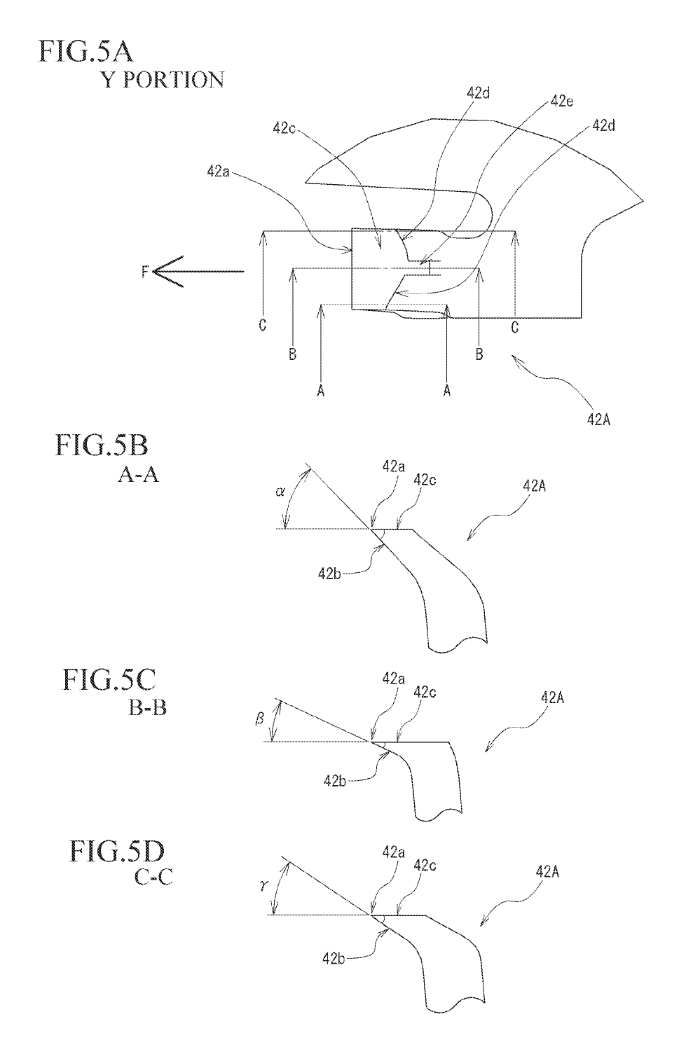

FIGS. 5A to 5D illustrate a configuration example of the small blade 42A according to the present embodiment. FIG. 5A is an enlarged view of a Y portion in FIG. 3B, that is, an enlarged plan view of the small blade 42A. In addition, FIG. 5B is a cross-sectional view taken along line A-A in FIG. 5A, that is, a cross-sectional view (cross-sectional view taken along a plane orthogonal to the radial direction) at a radially outer position of the small blade 42A. FIG. 5C is a cross-sectional view taken along line B-B in FIG. 5A, that is, a cross-sectional view (cross-sectional view taken along a plane orthogonal to the radial direction) at a radially center position of the small blade 42A. FIG. 5D is a cross-sectional view taken along line C-C in FIG. 5A, that is, a cross-sectional view (cross-sectional view taken along a plane orthogonal to the radial direction) at a radially′ inner position of the small blade 42A. As illustrated in FIGS. 5A to 5D, a rake angle at the radially outer position of the blade edge 42a is set to α, a rake angle at the radially center position of the blade edge 42a is set to β, and a rake angle at the radially inner position of the blade edge 42a is set to γ.

The small blade 42A according to the present embodiment is formed in a shape in which the rake angles of the blade edge 42a are a small angle and a large angle depending on the radial positions of the small blade 42A.

For example, the small blade 42A is formed in a shape in which the rake angle β at the radially center position of the blade edge 42a is a relatively small angle. In contrast, the small blade 42A is formed in a shape in which the rake angle α at the radially outer position of the blade edge 42a is a relatively large angle and the rake angle γ at the radially inner position of the blade edge 42a is a relatively large angle. A relationship between α and γ is not particularly limited. Any one may be larger, or both of these have the same size.

More specifically, the small blade 42A according to the present embodiment is formed so that shapes of the blade edge 42a satisfy β<α and β<γ. As described above, the relationship between α and γ may be either γ≦α or α≦γ.

As an example, the small blade 42A is formed so that the shapes of the blade edge 42a show β<α and β<γ among α,β, and γ which respectively satisfy 30°≦α≦80 °, 20°≦β≦45°, and 30°≦γ≦80°.

According to this configuration, the small blade 42A is configured to include a portion (that is, radially central position of the blade edge 42a) having a relatively small angle, that is, a sharp rake angle in the blade edge 42a. When hair X is cut at the corresponding portion, an advantageous effect of improved cutting quality can be obtained. However, since the corresponding portion is formed so that the rake angle of the blade edge 42a is small, the shape of the blade edge 42a becomes relatively thin, thereby weakening the rigidity. Accordingly, there is a problem in that the cutting quality decreases since the blade edge 42a gradually becomes blunt as the blade edge 42a is used (cuts the hair) frequently.

On the other hand, the small blade 42A is configured to include a portion having a relatively large rake angle, that is, an obtuse rake angle in the blade edge 42a (that is, radially outer portion and radially inner portion of the blade edge 42a). Since the corresponding portions are formed so that the rake angle of the blade edge 42a is large, the shape of the blade edge 42a becomes relatively thick, thereby enabling the rigidity to be strengthened. Accordingly, it is possible to prevent the cutting quality from decreasing since the blade edge 42a gradually becomes blunt as the blade edge 42a is used (cuts the hair) frequently.

In this manner, conflicting problems can be solved by adopting a configuration in which the small blade 42A of the inner blade 42 according to the present embodiment includes the blade edge 42a formed in a shape in which the rake angle β at the radially center position is small and the rake angles α and γ at the radially outer position and the radially inner position are large. That is, it is possible to improve and maintain the cutting quality when hair is cut, and it is possible to prevent the blade edge 42a from gradually becoming blunt as the blade edge 42a is used repeatedly.

In addition, in an upper end portion region including the upper end surface 42c in the small blade 42A, a thin portion 42d formed by reducing a rear side region in the rotation direction on a cross section parallel to the rotation surface (cross section taken by a plane parallel to the plate surface 42B of the metal plate) is formed in a partial region (in the present embodiment, radially outer position and inner position) in the direction orthogonal to the rotation direction (that is, radial direction). In contrast, a portion which does not reduce the rear side region in the rotation direction on the cross section parallel to the rotation surface is formed in the remaining region in the radial direction (in the present embodiment, radially center position) as a thick portion 42e.

That is, dimensions in the rotation direction show a shape in which the thin portion 42d is relatively short and the thick portion 42e is relatively long. In the present embodiment, the upper end surface 42c is formed in a convex shape protruding rearward in the rotation direction (refer to FIG. 5A). As an example, the thin portion 42d is formed by means of pressing. However, the present embodiment is not limited to the processing method.

According to this configuration, in the upper end portion region of the small blade 42A, the thin portion 42d is formed in a partial region in the radial direction. In this manner, as compared to a case where the upper end portion of the small blade 42A formed upright is simply cut by a plane parallel to the rotation direction, it is possible to further minimize an area of the upper end surface 42c which is formed by the upper end portion of the small blade 42A being polished. In this way, it is possible to further minimize the area of the upper end surface 42c of the small blade 42A which comes into sliding contact with the lower surface 22b of the outer blade 22. Accordingly, it is possible to decrease sliding resistance.

Here, if all regions in the radial direction are formed as the thin portion. 42d, strength in the upper end portion of the small blade 42A cannot be ensured. In contrast, in the present embodiment, a configuration is adopted in which the thin portion 42d is formed in a partial region in the radial direction and the thick portion 42e is formed in the remaining region. Accordingly, the thick portion 42e can function as a reinforcing rib. As a result, the strength in the upper end portion of the small blade 42A can be ensured while the area of the upper end surface 42c of the small blade 42A is minimized.

In particular, according to the present embodiment, it is possible to ensure the strength at the radially center position of the upper end portion of the small blade 42A. Therefore, it is possible to realize a configuration in which the rake angle of the blade edge 42a at the radially center position is formed to be a relatively small angle.

As described above, according to the rotary electric shaver according to the present invention, it is possible to improve and maintain the cutting quality when hair is cut. In the meanwhile, it is possible to prevent the blade edge from gradually becoming blunt as the blade edge is used frequently. In this way, conflicting problems can be solved.

Without being limited to the above-described embodiment, the present invention can be modified in various ways within the scope not departing from the gist of the present invention. In particular, as an example, the rotary electric shaver has been described which includes three sets of combination (blade unit) between the outer blade and the inner blade. However, the present invention is not limited thereto.

What is claimed is:

1. A rotary electric shaver comprising:
a blade unit including an outer blade having multiple hair inlets formed therein and an inner blade rotating while coming into sliding contact with a lower surface of the outer blade, wherein
the inner blade has multiple small blades, and
the small blades are formed in a shape in which rake angles of a blade edge are a small angle and a large angle depending on radial positions of the small blade.

2. The rotary electric shaver according to claim 1, wherein
the small blades are formed in a shape in which a rake angle β at a radially center position of the blade edge is a relatively small angle, and in which a rake angle α at a radially outer position and a rake angle γ at a radially inner position of the blade edge are relatively large angles.

3. The rotary electric shaver according to claim 1, wherein
the small blades are formed in a shape in which β<α and β<γ are satisfied when the rake angle at the radially outer position of the blade edge is set to α, the rake angle at the radially center position of the blade edge is set to β, and the rake angle at the radially inner position of the blade edge is set to γ.

4. The rotary electric shaver according to claim 2, wherein
the small blades are formed in a shape in which β<α and β<γ are satisfied when the rake angle at the radially outer position of the blade edge is set to α, the rake angle at the radially center position of the blade edge is set to β, and the rake angle at the radially inner position of the blade edge is set to γ.

5. The rotary electric shaver according to claim 3, wherein
the small blades are formed in a shape in which β<α and β<γ are satisfied when 30°≦α≦80°, 20°≦β≦45°, and 30°≦γ80° are satisfied.

6. The rotary electric shaver according to claim 4, wherein
the small blades are formed in a shape in which β<α and β<γ are satisfied when 30°≦α≦80°, 20°≦β≦45°, and 30°≦γ≦80° are satisfied.

7. The rotary electric shaver according to claim 1, wherein
the small blades have a thin portion formed by reducing a rear side region in a rotation direction on a cross section parallel to a rotation surface, in an upper end portion region including an upper end surface.

8. The rotary electric shaver according to claim 2, wherein
the small blades have a thin portion formed by reducing a rear side region in a rotation direction on a cross section parallel to a rotation surface, in an upper end portion region including an upper end surface.

9. The rotary electric shaver according to claim 3, wherein
the small blades have a thin portion formed by reducing a rear side region in a rotation direction on a cross section parallel to a rotation surface, in an upper end portion region including an upper end surface.

10. The rotary electric shaver according to claim 4, wherein
the small blades have a thin portion formed by reducing a rear side region in a rotation direction on a cross section parallel to a rotation surface, in an upper end portion region including an upper end surface.

11. The rotary electric shaver according to claim 5, wherein
the small blades have a thin portion formed by reducing a rear side region in a rotation direction on a cross section parallel to a rotation surface, in an upper end portion region including an upper end surface.

12. The rotary electric shaver according to claim 6, wherein
the small blades have a thin portion formed by reducing a rear side region in a rotation direction on a cross section parallel to a rotation surface, in an upper end portion region including an upper end surface.
